(19) United States
(12) Patent Application Publication
(10) Pub. No.: US 2024/0083110 A1
(43) Pub. Date: Mar. 14, 2024

(54) 3D PRINTING PROCESS AND MOLDING PRODUCED BY THIS PROCESS USING LIGNOSULFATE

(71) Applicant: Voxeljet AG, Friedberg (DE)

(72) Inventors: Ingo Gnüchtel, Villenbach (DE); Florian Mögele, Gessertshausen-Döpshofen (DE)

(21) Appl. No.: 18/378,732

(22) Filed: Oct. 11, 2023

Related U.S. Application Data
(63) Continuation of application No. 17/772,338, filed on Apr. 27, 2022, now Pat. No. 11,820,076.

(30) Foreign Application Priority Data
Nov. 1, 2019 (DE) 10 2019 007 595.1

(51) Int. Cl. B29C 64/165; B29C 33/38; B29C 64/264

(52) U.S. Cl. CPC B29C 64/165; B29C 33/3807; B29C 33/3814; B29C 33/3842; B29C 64/264; B33Y 10/00

(57) ABSTRACT

The present invention relates to a material system for 3D printing, to a 3D printing process using a lignin-containing component or derivatives thereof or modified lignins, to soluble moldings that are produced by a powder-based additive layer manufacturing process and to the use of the moldings.

### FIELD

The present invention relates to a material system for 3D printing, to a 3D printing process using a lignin-containing component or derivatives thereof, to soluble moldings that are produced by a powder-based additive layer manufacturing process, and to the use of the moldings.

### BACKGROUND

European Patent EP 0 431 924 B1 describes a process for producing three-dimensional objects based on computer data. In the process, a thin layer of particle material is deposited on a platform and has a liquid selectively printed thereon by means of a print head. In the area printed with the liquid, the particles become bonded and the area solidifies under the influence of the liquid and, if necessary, an additional hardener. Next, the platform is lowered by one layer thickness in a building cylinder and provided with a new layer of particle material, the latter also being printed on as described above. These steps are repeated until a certain desired height of the object is achieved. Thus, the printed and solidified regions form a three-dimensional object.

This method allows the processing of different particle materials, including—as a non-exhaustive example—natural biological raw materials, polymeric plastic materials, metals, ceramics and sands.

Sand particles, for example, can be processed with binder systems through powder-based 3D printing. These include cold resin bonding, which is used in foundry applications as well as in 3D printing.

Inorganic binders are also used in this field. In the foundry industry, they are the environmentally friendly alternative to cold resin binders.

These materials are particularly suitable for metal casting, where high temperatures usually prevail and where the organic binder burns to a large extent and pre-weakens the mold. In the subsequent step, after the melt has cooled, the mold residues are removed mechanically. In the case of inorganically bonded molds, high energies must be applied to prevent weakening of the mold during casting.

For cold casting with synthetic resins or hydraulically setting systems such as concrete, none of the previously mentioned molds are weakened. The surface of the sand molds must be coated and sealed prior to cold casting and a release agent must be applied to facilitate the separation of the interfaces after the casting material has cured.

While outer molds can still be removed from the mold, it is disadvantageously not possible to produce inner structures of the casting with insert cores, since mechanical removal of the insert core is practically impossible without damaging the final mold.

The situation is similarly disadvantageous when using the printed sand molds as a laminating tool. Simple surface textures can be easily produced on coated surfaces, but this is not possible for undercuts or overhangs. While it is still possible, with certain geometries, to mechanically destroy the mold and thus expose the laminate, this is impossible with almost closed structures and will damage the laminate.

Thus, no or only insufficiently satisfactory processes are known to date that make it possible to produce complicated laminated moldings. However, satisfactory processes and material systems for 3D printing are not available for both laminated moldings and cold casting molds with complicated geometries, such as undercuts.

It was therefore an object of the present invention to eliminate or at least substantially reduce the disadvantages of the prior art.

It was an object of the present invention to provide a material system and/or a 3D printing process that reduces or completely avoids the disadvantages of the prior art.

It was an object of the present invention to provide a material system and/or a 3D printing process that allows complicated geometries and laminated parts to be produced in a simple and cost-effective manner.

### SUMMARY OF THE INVENTION

In one aspect, the invention relates to a material system comprising a particle material or a mixture and a printing liquid.

In another aspect, the invention relates to a process of producing moldings that can be used as a laminating mold or cold casting mold and that can be easily removed by washing out with an aqueous solution or liquid, if necessary.

### BRIEF DESCRIPTION OF THE DRAWINGS

FIG. 1: illustration of a simple printed molding as a laminating mold for a laminate.

FIG. 2: washing out the laminate while destroying the printed part

FIG. 3: cored laminate

FIG. 4: finished laminate

FIG. 5: process sequence for cold casting with subsequent washing out of the mold

### DETAILED DESCRIPTION

A solution to the object underlying the invention in cold casting as well as in the production of laminates is a material system and/or a process for the production of 3D printed moldings, wherein a lignin or derivatives thereof are contained in the printing liquid, which moldings can preferably be demolded with the aid of a solvent such as water with destruction.

In one aspect, a solution is provided by a material system suitable for a 3D printing process or a 3D printing process material system comprising or consisting of a particle material and a printing liquid, wherein the particle material is selected from the group consisting of inorganic particle materials such as quartz sand, olivine sand, kerphalite, cerabeads, ceramics, metal powder or other organic particle materials such as wood powder, starch powder or cellulose powder, the particle material preferably being untreated, wherein the printing liquid comprises or consists of a liquid selected from the group consisting of water or an aqueous solution and a lignin-containing component or derivatives thereof, preferably lignosulfonate.

One of the advantages of the material system according to the invention is that it is cost-effective, since either inexpensive insoluble materials can be used or/and the insoluble particle material can be substantially reused. This is particularly advantageous in the case of expensive particle materials. Furthermore, lignin is a renewable raw material that is readily available and also inexpensive

Moreover, the printing liquid is easy to handle, environmentally compatible and gentle on the print head and its components, which represent a significant cost factor in 3D printing machines and their processes

In a material system according to the invention, the printing liquid may additionally include or comprise a component selected from the group consisting of water-soluble plastics such as polyvinyl pyrrolidone, polyethylene glycol, polyvinyl alcohol or polyacrylic acid, or other known water-soluble components that are compatible with the other material components.

In a material system according to the invention, the ratio of the individual components to one another is adjusted in such a way that a 3D printing process can be advantageously carried out and leads to the desired properties of the moldings produced.

In one aspect of the material system according to the invention, the printing liquid is equally adjusted and adapted to the other material components, wherein the printing liquid may consist of or comprise polar organic or/and inorganic fluids, preferably water and/or alcohols.

In a further aspect, the material system according to the invention is characterized in that the printing liquid consists of or comprises polar organic or/and inorganic liquids, preferably water and/or alcohols.

Preferably, the material system may be characterized in that it additionally contains a soluble starch hydrolysate, e.g. maltodextrin, glucose, preferably wherein the dextrose equivalent of the starch hydrolysate is between 1 and 50, preferably between 3 and 35, particularly preferably between 3 and 20.

In another aspect, the components of the material system can be adjusted differently in their ratio to each other. The lignin content in a printing fluid according to the disclosure may be between 10-35% (always based on the total mixture), preferably 10-25%, more preferably 15-20%; a starch hydrolysate may be present individually or in a mixture of several components in a proportion of between 10-35% (always based on the total mixture), preferably 10-25%, more preferably 15-20%; dispersing additives or/and surfactants may be present from between 0-3% (always based on the total mixture), preferably 0.1-1% may be present.

In a material system according to the invention, the alcohol content may be between 0.5%-15%, preferably 2%-10%, particularly preferably 5%-8% and/or wherein the alcohols comprise simple alcohols, diols or polyols or mixtures of the above.

In a material system according to the invention, the printing liquid is adjusted with regard to its viscosity in a suitable manner using suitable substances or liquids known to the skilled person. The viscosity can be between 2 mPas-20 mPas, preferably between 8 mPas-15 mPas and particularly preferably between 10 mPas-14 mPas.

In a material system according to the invention, the printing liquid may further comprise surfactants, such as sodium dodecyl sulfate or sodium laureth sulfate, and have a surface tension of 20 mN/m-50 mN/m, preferably 25 mN/m-40 mN/m and particularly preferably 28 mN/m-35 mN/m, or/and defoaming agents from, for example, the group of siloxanes or/and dyes.

In another aspect, the invention relates to a 3D printing process for producing a molding, said process comprising the steps of applying a particle material mixture onto a build plane, selectively applying a printing liquid, wherein the printing liquid comprises or consists of a liquid selected from the group consisting of water or an aqueous solution and a lignin-containing component or derivatives thereof, preferably lignosulfonate, for at least partial selective solidification, optionally tempering the build field or introducing energy into the applied particle material mixture, preferably tempering to 30° C. to 60° C., more preferably 40° C. to 50° C., and the printing liquid, repeating these steps until the desired molding has been obtained.

The advantage of this process is that moldings can be produced in good quality and can be used in a variety of applications and uses.

In particular, one advantage is that the moldings (also molds or casting molds) produced in this way can serve as laminating molds or for all purposes where the mold is to be removed again at the end of the process for which they are used. This can be done simply by adding water, which washes out the mold, allowing the product made with the mold to be gently freed from the mold.

In a 3D printing process according to the invention, the obtained molding can be separated from the non-solidified particle material mixture and the molding can preferably be subjected to a further heat treatment step.

As in all common 3D printing processes, e.g. inkjet processes, the particle material mixture is applied by means of recoaters and, if necessary, the particle material mixture is mixed before application.

As in all common 3D printing processes, e.g. inkjet processes, the printing liquid is selectively applied with a print head.

In a 3D printing process according to the invention, the molding can be left in the powder bed at ambient conditions for 4 h-24 h, preferably 8 h-15 h, particularly preferably 10 h-11 h, after completion of the printing process.

The 3D printing process according to the invention can be followed by further procedures. For example, in an additional step, the molding is subjected to heat treatment, preferably the molding is stored 1 h-7 h, preferably 4 h-6 h, at 30° C.-160° C., preferably at 50° C.-140° C.

In the 3D printing process according to the invention, air can be sucked through the printed and non-printed build volume to increase unpacking strength. Suction is preferably started 0.5 h-8 h after completion of mold production (end of job), preferably 1 h-5 h, particularly preferably 1 h-3 h after completion of the building process. The air sucked through may have a temperature that varies from room temperature, the air sucked through preferably having a temperature of 10° C.-80° C., preferably 15° C.-60° C., particularly preferably 20° C.-40° C. Suction is applied, preferably for 0.5 h-3 h, and particularly preferably for 1 h-2 h. A downstream heating process of the parts in the oven can be carried out additionally to further increase the strength. Preferably, the molding is stored for 1 h-7 h, preferably 4 h-6 h, at 30° C.-160° C., preferably at 50° C.-140° C. Post-treatment can also be carried out with microwave radiation in addition to or as a substitute for the heat treatment in the oven, the treatment taking place over a period of 2 min-30 min, preferably 2 min-15 min, particularly preferably 2 min-10 min.

Another possibility of a subsequent step in a 3D printing process according to the invention is to further coat or seal the surface of the molding, in which case all processes and materials known to the skilled person can be used here for such moldings.

The moldings produced by the 3D printing process of the invention can be used in a wide variety of applications, e.g. in lamination processes for the production of tubes or hoses for aerospace or similar applications.

The material properties of the moldings produced by the 3D process according to the invention are advantageous and can be further influenced in certain material properties by suitable subsequent steps of the process. For example, on the one hand, strength can be influenced by the amount of water-soluble component in the printing liquid and the amount of printing liquid applied to the particle material, and on the other hand, strength can be adjusted by leaving the molding in the powder bed or by a subsequent heat treatment, as well as by allowing air to pass through by suction. A molding left in the powder bed for a further 4 h-24 h, preferably 8 h-15 h, particularly preferably 10 h-11 h, at ambient conditions can exhibit strengths of 80 N/cm²-150 N/cm² in the direction of printing. Due to the air passing through by suction, said strength is achieved after a shorter time. After heat treatment for 1 h-7 h, preferably 4 h-6 h, at 30° C.-160° C., preferably at 50° C.-140° C., strengths of more than 200 N/cm² may result.

In a further aspect, the invention relates to the use of a molding produced according to the invention or produced by a process according to the invention for cold casting of synthetic resins or hydraulically setting systems or as a laminating mold.

Other aspects of the invention will be described below.

Prior to the actual 3D printing process according to the invention, the inert particle material, such as the sands already known to be used in powder bed-based 3D printing, such as quartz sand, olivine sand, kerphalite or cerabeads, but also insoluble plastics, need not be mixed with further soluble organic substances.

The advantage of the above particle materials is that no changes to existing recoater technology are required and standard 3D printers capable of processing particle material in furan resin, phenolic resin and inorganic processes can be used.

In the case of mixtures of particle materials, the particle sizes are preferably between 90 μm and 250 μm, although finer powders are also suitable. This largely prevents segregation during transport of the particle material.

Mixed powders are usually already homogenized upstream of the process in a discontinuous mixer.

The liquid second component, i.e. a printing liquid, is introduced via a print head which is guided in a meandering manner over the coated first component, selectively according to the data of the respective layer pattern with a previously defined entry related to the weight of the particle material.

The printing liquid (the liquid component) consists largely of a solvent (dissolvent) that transfers the soluble material to the particle material. Preferably, the solvent is water.

To ensure that water can be processed in a pressure-stable manner, on the one hand the surface tension is lowered from about 72 mN/m to preferably below 40 mN/m, particularly preferably between 30 mN/m and 35 mN/m, by adding a surfactant. Only small quantities are added for this purpose, since high quantities promote foam formation and can lead to nozzle failures during printing. For this reason, only amounts up to 1% of a surfactant such as sodium dodecyl sulfate, sugar-based surfactants, SURFYNOL® 440 surfactant, SURFYNOL® 465 surfactant, CARBOWET® 104 surfactant are added to the printing liquid.

The occurrence of foam is reduced by adding defoaming agents, e.g. from the group of siloxanes such as TECO® FOAMEX 1488 defoamer, and usually adding up to 0.5% of the printing liquid.

The viscosity of the printing liquid is adjusted to a range of 4 mPas-20 mPas by adding readily water-soluble alcohols. Preferably, polyhydric alcohols such as glycol, propylene glycol, polyethylene glycol, polyvinyl alcohol or soluble sugars are used, their content being up to 20%. Particularly preferably, maltodextrin is added in an amount of 15%-20%, resulting in a viscosity of 11 mPas-15 mPas.

Furthermore, the dark, brown coloration of the printing liquid can be adjusted in its coloration by adding suitable dyes. Typically, small amounts of a readily soluble dye such as BASACIDE®, ORASOLE® or polymer dyes such as Milliken Red 17 are used. Amounts typically added are in the range of 0.1%-0.5%, preferably 0.2%-0.3%.

After printing the layer, the build platform is moved relative to the printing unit by one layer thickness and new powder material is applied.

In this case, an infrared lamp, which is located on the recoater axis and/or has a separate axis and/or is mounted on the print head axis, can heat the printed and/or the freshly applied layer by passing over the latter once or several times. The increased temperature helps to reduce the amount of liquid again by evaporation. In addition to increasing the strength of the parts, the heating step also advantageously produces a higher contour sharpness, since the diffusion of the binder is reduced by the aforementioned processes.

The surface temperature during the process is between 30° C. and 60° C., preferably 40° C.-50° C.

After completion of the build process, another 3 mm-30 mm, preferably 10 mm, of empty layers are applied to completely embed the last built parts in loose material.

After a waiting time of 4 h-24 h, preferably 8 h-12 h, and particularly preferably 10 h-11 h, the part can be freed from loose material, for example by means of a suction device. The unbonded powder can be returned to the process after control screening.

Finally, the parts are freed of any remaining adhering material using compressed air. The strengths of 80 N/cm²-150 N/cm² are rather weak but strong enough to handle them without destruction or deformation.

Strength increase can be generated by post-treatment in the oven at preferably 100° C.-140° C. for 3 h-5 h, reaching final strengths of >200 N/cm².

Since the 3D printed moldings have a porous surface, it is usually advantageous to treat the surface of the printed part before using it as a casting or laminating mold. This reduces the porosity at the interface to such an extent that, in the further application step, the surface of the printed material can no longer be penetrated and the cast or laminate can be delineated from the printed part. The built mold is assembled or inserted into conventionally manufactured outer molds and poured with a resin such as epoxy, polyurethane or polyester resin. Furthermore, silicones or hydraulically setting material systems can also be used. In addition, laminates based on glass or carbon fiber can be produced on the basis of the part surfaces.

After curing of the material systems, demolding is carried out by bringing solvent, preferably water, into contact with the mold. This can be done, for example, by dipping the mold in the solvent or pouring the solvent over the mold. The soluble component now dissolves rapidly, breaking the cohesion of the insoluble powder.

The insoluble component is also flushed out, can be collected, remixed with soluble material and returned to the process. To release the built part, a sufficiently large gap is sufficient from which the insoluble material can flow out together with the solvent.

Several terms according to the invention will be explained in more detail below.

In the sense of the invention, “3D printing methods” are all methods known from the prior art which enable the construction of parts as three-dimensional molds and are compatible with the described process components and devices.

“Selective printing liquid application” in the sense of the invention may be effected after each application of particle material—or of a particle material mixture—or irregularly, i.e. non-linearly and parallel after each particle material application, depending on the requirements for the molded article and for optimization of the molded article production. Thus, “selective printing liquid application” may be adjusted individually, during the course of the molded article production.

“Binders” in the sense of the invention are materials which, by means of dissolution by a solution or solvent, e.g., an aqueous solution, cause solid and insoluble particles, e.g., sands, in a particle material to adhere to each other and produce relative strength between the particles.

A “molded article” or “part” or “mold” or “3D molding” in the sense of the invention means all three-dimensional objects manufactured using the process (3D printing process) according to the invention and exhibiting dimensional stability.

The “particle materials” or “insoluble particle materials” of use herein may be any materials known for powder-based 3D printing (e.g. inkjet process), in particular sands, ceramic powders, metal powders, plastic materials, wood particles, fiber materials, celluloses or/and lactose powders. The particle material is preferably a free-flowing powder when dry, but may also be a cohesive, cut-resistant powder or a particle-charged liquid.

“Particle material” or “particle material mixture” in the sense of the invention refers to a mixture of two or more different materials, e.g., a water-soluble particle material and a water-insoluble particle material, the individual materials being further described in the present disclosure.

A “material system” in the sense of the invention consists of various components which, by their interaction, permit the layer-by-layer construction of moldings; these various components can be applied and deposited together or successively in layers. Individual components such as binder components can be present in one or both material components and these then have an influence on, for example, the strength of the molding produced.

A “printing liquid” in the sense of the invention is used to be selectively applied to the applied particle material mixture and to selectively achieve the formation of a molded article. The printing liquid may contain binder materials, and these binder materials may be present substantially exclusively in the particle material mixture, present substantially exclusively in the printing liquid, or present in both components. A “printing liquid” in the sense of the invention comprises or consists of a liquid selected from the group consisting of water or an aqueous solution and a lignin-containing component or derivatives or modified lignins thereof, preferably lignosulfonate.

The “build area” is the geometric location where the particle material bed grows during the build process by repeated coating with particle material. The build area is generally bounded by a bottom, i.e. the build platform, by walls and an open top surface, i.e. the build plane.

“Casting material” in the sense of this invention means any castable material, in particular those in the processing of which no temperatures occur which could weaken a cold-resin bond and thus favor demolding.

For the purposes of the invention, “porosity” is a labyrinthine structure of cavities created between particles bonded in the 3D printing process.

The “sealing” acts at the geometric boundary between the printed mold and the cavity to be filled. It superficially seals the pores of the porous molded article.

“Cold casting processes” refers, in particular, to casting processes in which the temperature of the mold and core does not reach the decomposition or softening temperature of the mold material before, during and after casting. The strength of the mold is not affected by the casting operation. This would be contrasted with metal casting processes, in which the mold is generally slowly destroyed by the hot casting compound.

The term “treated surface” refers to a surface of the casting mold that is treated in a preferably separate step after printing and cleaning the mold. This treatment is often an application of a substance to the surface and thus into the areas of the mold or core near the surface. For the application all conceivable different procedures come into consideration.

It is economically desirable, especially for more complex shapes, to realize molds for cold casting and laminating molds via 3D printed molds.

One aspect of the present invention is to provide a mold, particularly for use in cold casting and laminating processes, made by a powder-based additive layer manufacturing process, wherein the final mold may optionally have a treated surface and may be weakened and demolded by a solvent.

The treated surface can, for example, prevent castable material systems or liquid binders from penetrating the molded article due to hydrostatic pressure or capillary effects.

Further embodiments or/and aspects of the invention will be presented below.

According to a preferred embodiment, the invention comprises a material system comprising a mixture of a particle material, wherein at least one powder component is soluble in a second liquid component.

In another aspect, the invention relates to a first material component consisting of at least one insoluble inorganic and/or organic particle material and a soluble, preferably water-soluble, polymer having a similar particle size distribution.

In another aspect, the invention relates to a second material component consisting largely of a solvent and additives for adjusting viscosity and surface tension.

Furthermore, the invention relates to the production of water-soluble molds by means of powder bed-based 3D printing in an additive layer manufacturing process and with a liquid component that is selectively introduced into the particle material.

Due to the soluble properties of a component of the particle material, a molded article made from it by 3D printing can be destroyed again under mild conditions by exposure to a solvent, preferably water.

In another aspect, the invention relates to a use of the mold according to the invention for producing cold castings as a lost mold or laminate.

In particular, the casting molds according to the invention can be used to produce concrete castings and/or cold-cast polymer parts.

Preferably, a powder bed-based 3D printing process is used for the additive layer manufacturing process.

If the surface is additionally sealed with a hydrophobic material, if necessary, the penetration of the casting material into the pores of the mold can be well restricted.

Furthermore, it is possible to change the porosity of the surface by a sizing agent and/or dispersion, in particular a zirconium oxide, aluminum oxide, calcium oxide, titanium oxide, chalk or silicic acid-based sizing agent and/or a plastic, cellulose, sugar, flour and/or salt-based solution.

Moreover, the porosity of the surface can be changed or sealed by a grease, oil, wax and/or hot water soluble substances.

### EXEMPLARY EMBODIMENTS

A. An exemplary device for producing a molding in accordance with the present invention includes a powder recoater. Particle material is applied onto a build platform and smoothed by the powder recoater. The applied particle material can consist of a wide variety of insoluble materials, but according to the invention, sand mixed with a water-soluble polymer is preferred due to its low cost. The height of the powder layers is determined by the build platform. The build platform is lowered after application of one layer. In the next coating process, the resulting volume is filled and the excess is smoothed down. The result is a substantially or even almost perfectly parallel and smooth layer of a defined height.

After a coating and, if necessary, heating process, a liquid that transfers the soluble polymer to the particle material is printed on the layer using an inkjet print head. The print image corresponds to the section through the part at the current build height of the device. The liquid impacts the particle material and slowly diffuses into it.

The soluble binder physically bonds the surrounding loose insoluble particles together. Initially, the bond is only of low strength.

In the next step, the build platform is lowered by one layer thickness and the layer is also additionally heated by means of heat. The layer-forming, printing/exposure, heating and lowering steps are repeated only until the desired part has been completed.

The part is now completely present in the powder cake. In the final step, the part is freed from loose particle material. In addition, cleaning of loose powder material can follow by means of compressed air.

B. The bonded build volume surrounded by unbonded build volume can be dried faster by sucking air through it.

C. The produced part can then still be dried in the oven to further increase the strength. After treatment of the surface, the part can be used for cold casting or as a laminating mold.

D. Depending on the application purpose and required surface quality, different average particle sizes of insoluble particle material and soluble polymer are used. For high surface qualities, for example, sands and soluble polymer with an average particle diameter of 60 μm-90 μm are used, allowing a very fine layer height of 150 μm to be selected. Coarser particles with e.g. a d₅₀=140 μm-250 μm allow only 250 μm-400 μm layer heights. This yields coarser surfaces. The building speed is also influenced by the fineness of the particle material.

Two examples each of a particle material with a soluble component and a liquid material are shown below, together with examples of the properties of resulting parts.

E. Exemplary Particle Materials:

### Example 1

Particle material consisting of sand with an average particle size of 150 μm (95%) and sand with a d₅₀ of 190 μm (5%) is mixed in a conical screw mixer for 1 h and then screened (250 μm mesh size).

### Example 2

Particle material consisting of softwood fibers (80%, e.g. LIGNOCEL®) and starch powder (20%) are mixed in a conical screw mixer for 1 h and then screened (250 μm mesh size).

F. Exemplary Printing Liquids

Composition of an Exemplary Printing Liquid (Liquid Component)

While stirring at 300 rpm with a blade mixer, lignosulfonate (25%) is added to distilled water (52%) in portions and stirred until the solid is completely dissolved. Then maltodextrin (12%) and glucose (10%) are also added in portions followed by SURFYNOL® (0.8%) and finally Zetasperse®179 (0.2%). After stirring for another hour at 600 rpm, the mixture is filtered (mesh size <1 μm) (the specified quantities refer to 100% of the total mixture).

G. An Exemplary Printing Process

Before the actual printing process, the build platform is covered with a layer of foundry sand with an average particle size of 140 μm and heated to a surface temperature of 90° C. using IR radiation. The layer-by-layer printing process then takes place, with printing liquid being introduced via the print head, in accordance with the build data, in an amount of 15% based on the mass of the particle material.

H. An Exemplary Post-Processing Step (Optional)

After completion of the print job, negative pressure is applied to the box for 1 h, drawing ambient air through the powder cake and drying the parts. After unpacking and finishing, the parts have a 3-point bending strength of 210 N/cm² and a residual moisture content of 0.3%. At a maximum relative humidity of 60%, the parts can be stored without deformation.

Further explanations of the Figures describe various aspects of the invention:

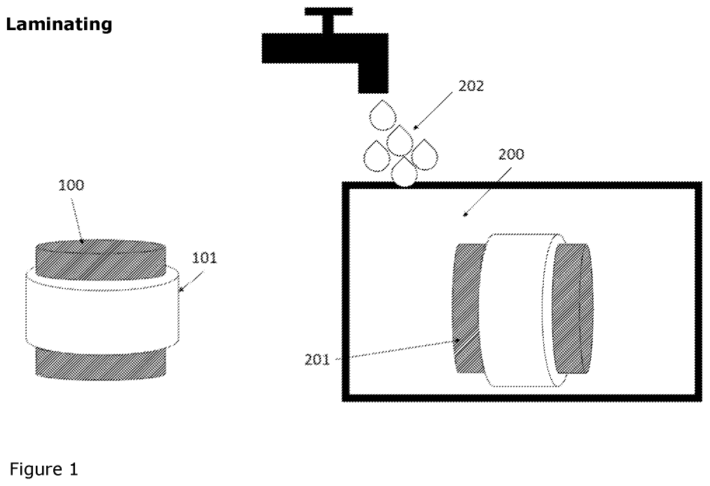

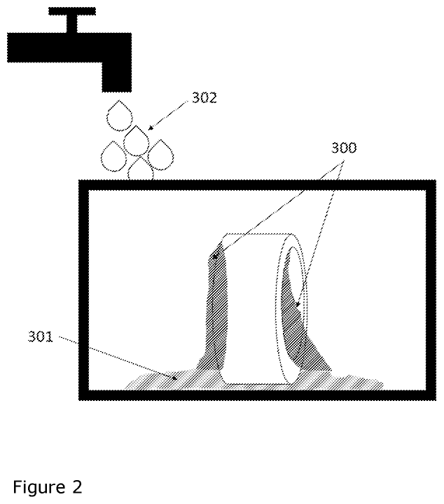

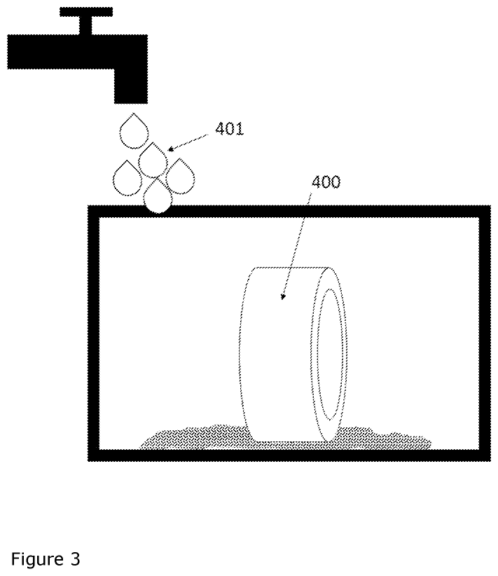

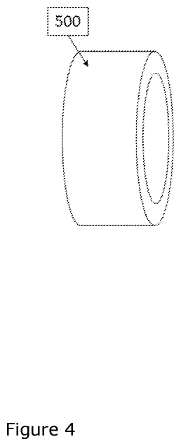

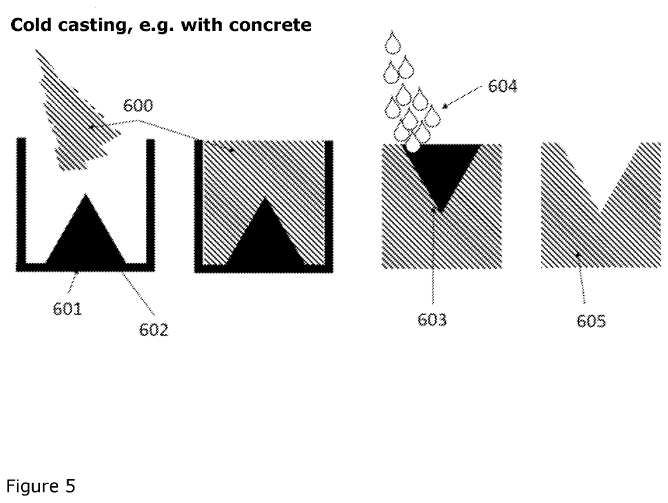

FIG. 1 shows the use of the prepared water-soluble core (100) as a laminating mold with laminate (101) already surrounding it. After the resin has cured, the mold is placed in a water basin (200) and additionally washed out with a water jet (202). FIG. 2 shows the dissolving mold (300). The insoluble component of the particle material (301) collects at the bottom of the water basin. After complete dissolution of the soluble component, the laminate (400) remains and can still be completely cleaned under a water jet (401) (FIG. 3). FIG. 4 shows the cleaned and dried laminate. FIG. 5 shows the application in cold casting. First, the water-soluble mold (602) is placed in a mold (601). The material to be cast, e.g. epoxy resin or concrete (600), is poured into the mold. After the casting material has cured, usually after 24 h, the core is again demolded under mild conditions by means of a dip tank and/or water jet (604). The remaining insoluble material can be reintroduced into the printing process after drying and mixing with the soluble portion. As a result, the process achieves a high level of cost-effectiveness, which is a great advantage, especially when using special sands.

### LIST OF REFERENCE NUMERALS

100 water-soluble core
101 laminate surrounding the water-soluble core
200 water basin
201 water-soluble core with laminate
202 water
300 core dissolves
301 insoluble particle material
302 water
400 cored laminate
401 water
500 finished laminate
600 concrete
601 formwork
602 water-soluble core
603 washing out with water
604 water
605 cored concrete part

1-3. (canceled)

4. A process for producing a laminated part comprising the steps of:
applying a laminating material over a laminating mold;
washing out the laminating mold with a solvent;
wherein the laminated part includes one or more undercuts; and
the laminating mold is porous and includes a non-soluble particulate material bonded by a soluble polymer.

5-20. (canceled)

21. The process of claim 4, wherein the laminating material includes an epoxy resin, a polyurethane, a polyester resin, a hydraulically setting material system, or a silicone.

22. The process of claim 4, wherein the laminating material includes a glass or carbon fiber.

23. The process of claim 4, wherein the solvent is water.

24. The process of claim 23, wherein the laminating material is insoluble in water.

25. The process of claim 4, wherein the soluble polymer includes a polyvinyl pyrrolidone, a polyethylene glycol, a polyvinyl alcohol, or a polyacrylic acid.

26. The process of claim 4, wherein the insoluble particles include an inorganic particle.

27. The process of claim 26, wherein the inorganic particle includes quartz sand, olivine sand, kerphalite, cerabeads, ceramics, or metal powder.

28. The process of claim 4, wherein the insoluble particle includes wood powder, starch powder, or cellulose powder.

29. The process of claim 4, wherein the laminating mold includes a lignin-containing compound.

30. The process of claim 29, wherein the lignin-containing compound includes a lignosolufate.

31. The process of claim 4, wherein the laminating mold is produced by a printing process and has a strength of 80 N/cm² to 150 N/cm² in a printing direction.

32. The process of claim 4, wherein the process includes a step of curing the laminating material.

33. The process of claim 4, wherein the process includes dipping the laminating mold into the solvent or pouring the solvent over the laminating mold to dissolve the water-soluble polymer and break cohesion of the insoluble particle.

34. The process of claim 4, wherein the laminating mold is superficially sealed.

35. The process of claim 4, wherein the laminating mold is treated to prevent laminating material from penetrating the laminating mold due to hydrostatic pressure or capillary effects.

36. The process of claim 4, wherein the insoluble particle material has a particle size of 90 μm to 250 μm.

37. The process of claim 4, wherein the porosity of a surface of the laminating mold is modified with a grease, oil, wax, or hot water-soluble substance.

39. The process of claim 4, wherein the laminating mold includes a surfactant for reducing a surface tension.
